(19) United States
(12) Patent Application Publication
(10) Pub. No.: US 2013/0283284 A1
(43) Pub. Date: Oct. 24, 2013

(54) OPERATION MANAGEMENT APPARATUS, OPERATION MANAGEMENT METHOD AND OPERATION MANAGEMENT PROGRAM

(71) Applicant: Yoshihiro OKADA, Tokyo (JP)

(72) Inventor: Yoshihiro OKADA, Tokyo (JP)

(73) Assignee: NEC Corporation, Tokyo (JP)

(21) Appl. No.: 13/845,322

(22) Filed: Mar. 18, 2013

(30) Foreign Application Priority Data
Mar. 22, 2012 (JP) 2012-064790

(51) Int. Cl. G06F 9/48

(52) U.S. Cl. CPC G06F 9/4881
USPC 718/103

(57) ABSTRACT

An operation management apparatus according to an exemplary aspect of the invention includes, an operation memory unit that stores a related operation and a priority corresponding to each of a plurality of control operations, the related operation being a different control operation from the corresponding control operations; an arithmetic processing unit that selects a target operation which is either one of the plurality of the control operations from the operation memory unit based on a predetermined condition, increases the priority of the target operation and increases the priority of the related operation which corresponds to the target operation; and an control operation derivation unit that selects a designated number of the control operations in the priority order from the operation memory unit and displays the selected control operations.

This application is based upon and claims the benefit of priority from Japanese Patent Application No. 2012-064790, filed on Mar. 22 And 2012, the disclosure of which is incorporated herein in its entirety by reference.

### TECHNICAL FIELD

The present invention relates to an operation management apparatus, a method and a program.

### BACKGROUND ART

An operation support system is described that electronically manages a work procedure of each operator, which is needed for the operation control of mobile objects, and its progress in Japanese Patent Application Laid-Open No. 2003-016156.

Supervisory control apparatus which displays symbols by the brightness corresponding to the order of the abnormal severity is described in Japanese Patent Application Laid-Open No. 1998-187232.

### SUMMARY

When the technology of the document mentioned above is used, the operation items in consideration of the dependency relationship among a plurality of control operations which occur in the system operation, is not displayed.

Although Japanese Patent Application Laid-Open No. 2003-016156 uses a statistical method such as a mean value and a standard deviation for the ordered determination (weighted) of the control operations, the dependency relationship among control operations is not taken into consideration.

Japanese Patent Application Laid-Open No. 1998-187232 is just a mechanism of abnormal monitoring limited to a specific apparatus, and does not consider the dependency relationship among control operations.

An exemplary object of the invention is to provide an operation management apparatus and so on for solving the problem mentioned above.

An operation management apparatus according to an exemplary aspect of the invention includes, an operation memory unit that stores a related operation and a priority corresponding to each of a plurality of control operations, the related operation being a different control operation from the corresponding control operations; an arithmetic processing unit that selects a target operation which is either one of the plurality of the control operations from the operation memory unit based on a predetermined condition, increases the priority of the target operation and increases the priority of the related operation which corresponds to the target operation; and an control operation derivation unit that selects a designated number of the control operations in the priority order from the operation memory unit and displays the selected control operations.

An operation management method according to an exemplary aspect of the invention includes, storing a related operation and a priority corresponding to each of a plurality of control operations, the related operation being a different control operation from the corresponding control operations; selecting a target operation which is either one of the plurality of the control operations from the operation memory unit based on a predetermined condition, increases the priority of the target operation and increases the priority of the related operation which corresponds to the target operation; and selecting a designated number of the control operations in the priority order from the operation memory unit and displays the selected control operations.

A non-transient computer-readable recording medium recording thereon a program which makes a computer having an operation memory unit that stores a related operation and a priority corresponding to each of a plurality of control operations, the related operation being a different control operation from the corresponding control operations, an arithmetic processing unit that selects a target operation which is either one of the plurality of the control operations from the operation memory unit based on a predetermined condition, increases the priority of the target operation and increases the priority of said related operation which corresponds to the target operation; and an control operation derivation unit that selects a designated number of the control operations in the priority order from the operation memory unit and displays the selected control operations.

### BRIEF DESCRIPTION OF THE DRAWINGS

Exemplary features and advantages of the present invention will become apparent from the following detailed description when taken with the accompanying drawings in which:

FIG. 1 shows an example of the composition of the execution prediction management system of system control operations.

FIG. 2 shows a composition example of the operation memory unit.

FIG. 3 shows an operation example of an operation management apparatus in the execution prediction management system in the system control operations.

FIG. 4 shows a screen example of a client terminal in the execution prediction management system of the system control operations.

FIG. 5 shows a screen example of control operations in a client terminal.

FIG. 6A is a flowchart showing the operations of the operation management apparatus when the control operations are carried out (1/3).

FIG. 6B is a flowchart showing the operations of the operation management apparatus when the control operations are carried out (2/3).

FIG. 6C is a flowchart showing the operations of the operation management apparatus when the control operations are carried out (3/3).

FIG. 7A is a flowchart showing the operation in the operation management apparatus when an event occurs (1/2).

FIG. 7B is a flowchart showing the operation in the operation management apparatus when an event occurs (2/2).

FIG. 8 is a flowchart showing the operation in the operation management apparatus when corresponding to the request of the restricted acquisition number of the control operations.

FIG. 9 shows a composition example of the execution prediction management system of system control operations according to the second embodiment.

FIG. 10 shows an operation example in the execution prediction management system of system control operations according to the second embodiment.

FIG. 11 shows a screen example of the client terminal in the execution prediction management system of system control operations according to the second embodiment.

FIG. 12 is a flowchart showing the operation in the execution prediction management system of system control operations according to the second embodiment.

FIG. 13 shows a composition example of the operation management apparatus according to the third embodiment.

### EXEMPLARY EMBODIMENT

### First Exemplary Embodiment

The first embodiment of the invention will be described in detail with reference to the drawings.

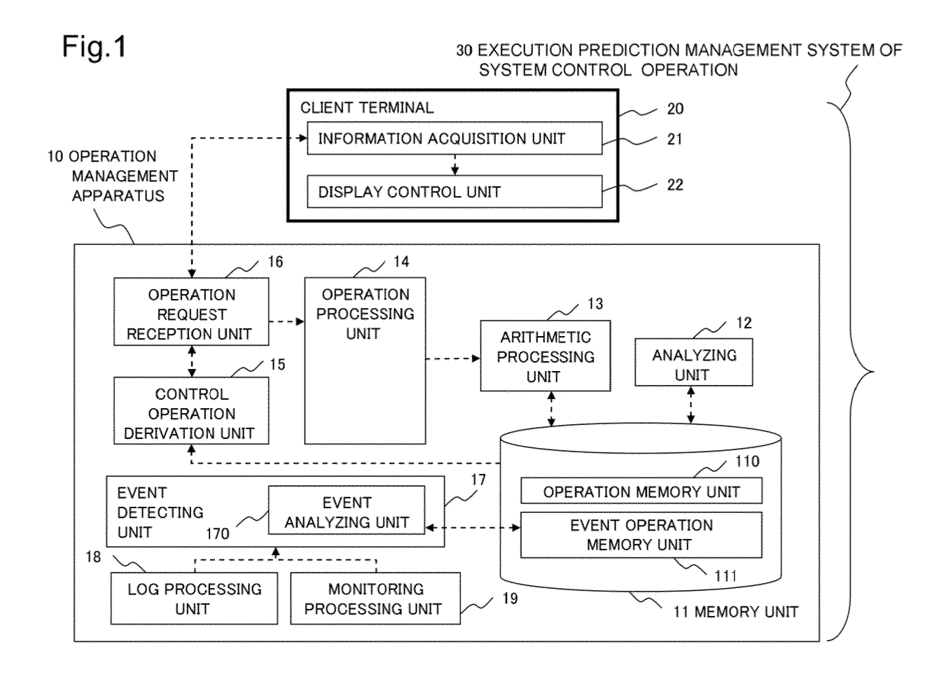

FIG. 1 shows a composition example of the execution prediction management system 30 of system control operations.

The execution prediction management system 30 of system control operations includes an operation management apparatus 10 and a client terminal 20. The operation management apparatus 10 and the client terminal 20 are connected in the state that mutual communication is available.

The operation management apparatus 10 includes a memory unit 11, an operation memory unit 110, an event operation memory unit 111, an analyzing unit 12, an arithmetic processing unit 13, an operation processing unit 14, a control operation derivation unit 15, an operation request reception unit 16, an event detecting unit 17, an event analyzing unit 170, a log processing unit 18 and a monitoring processing unit 19.

The memory unit 11 includes the operation memory unit 110 and the event operation memory unit 111.

The operation memory unit 110 stores the information concerning to all control operations including the control operations which a system operator has carried out in the past.

The event operation memory part 111 correlates and stores the control operations corresponding to the event which occurs in the operation management apparatus 10, that is, the related operations.

The analyzing unit 12 analyzes the information on the memory unit 11 and stores the result in the operation memory unit 110.

The arithmetic processing unit 13 carries out the operation to the numerical weighted values of each control operations, and outputs the numerical value after updating.

The operation processing unit 14 carries out the control operations.

The control operation derivation unit 15 acquires the designated number of control operations from the memory unit 11 and outputs to the client terminal 20.

The operation request reception unit 16 informs the output from the control operation derivation unit 15 to the client terminal 20 and outputs the request of control operations from the client terminal 20 to the operation processing unit 14.

The event detecting unit 17 detects the occurrence of logs and events by the input from the log processing unit 18 and the monitoring processing unit 19 and outputs the results to the event operation memory unit 111. The event detecting unit 17 includes the event analyzing unit 170.

Further, for example, the information outputted to the event detecting unit 17 includes the server name representing the kind of apparatus in which an event has occurred and the message which indicates the contents of the event.

The event analyzing unit 170 analyzes the data of the event detecting unit 17, specifies the kind of events and outputs to the event operation memory unit 111.

The log processing unit 18 outputs the log which has generated in the operation management apparatus 10 to the event detecting unit 17.

The monitoring processing unit 19 monitors the state of the component which operates inside the operation management apparatus 10 and outputs the result to the event detecting unit 17.

The client terminal 20 includes an information acquisition unit 21 and a display control unit 22 and connects with the operation management apparatus 10.

The information acquisition unit 21 requests and acquires the information concerning to the control operations to the operation management apparatus 10.

The display control unit 22 builds a screen of the client terminal 20 based on the information concerning to the control operations acquired in the information acquisition unit 21.

Here, the memory units 11, the operation memory unit 110 and event operation memory unit 111 are a disk apparatus and a semiconductor memory or the like.

The analyzing unit 12, the arithmetic processing unit 13, the operation processing unit 14, the control operation derivation unit 15, the operation request reception unit 16, the event detecting unit 17, the event analyzing unit 170, the log processing unit 18, the monitoring processing unit 19, the information acquisition unit 21 and the display control unit 22 are hardware such as a logic circuit.

The analyzing unit 12, the arithmetic processing unit 13, the operation processing unit 14, the control operation derivation unit 15, the operation request reception unit 16, the event detecting unit 17, the event analyzing unit 170, the log processing unit 18 and the monitoring processing unit 19 may be realized by the processor of the operation management apparatus 10 which is a computer executing a program on the memory which is not illustrated.

The information acquisition unit 21 and the display control unit 22 may be realized by the processor of the client terminal 20 which is a computer executing a program on the memory which is not illustrated.

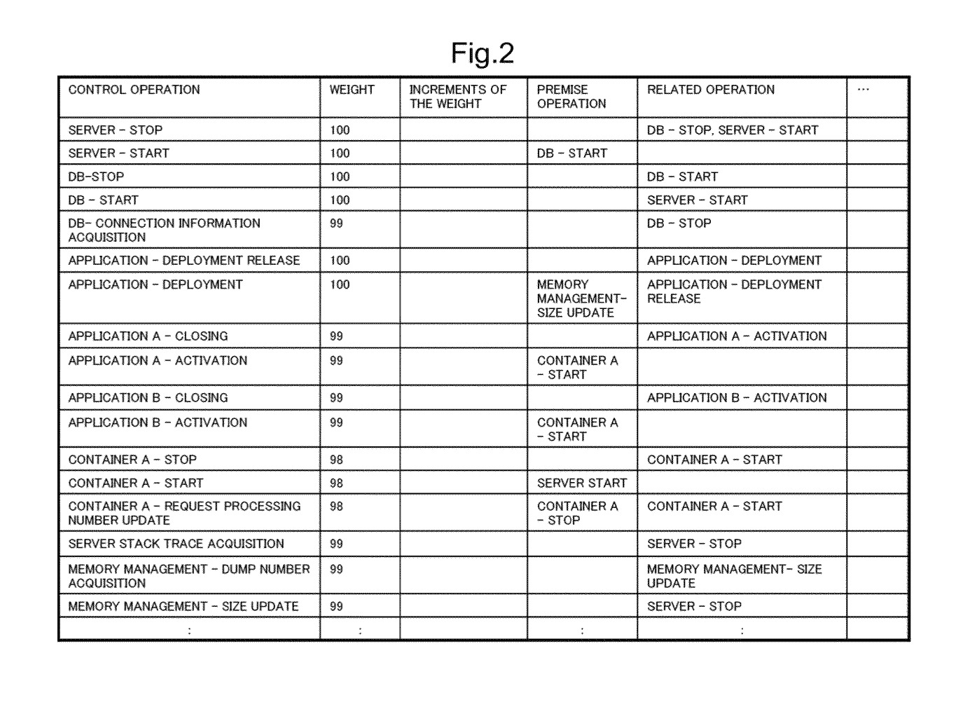

FIG. 2 shows a composition example of the data in the operation memory unit 110.

For example, FIG. 2 describes the weight, the increments of the weight, the premise operation and the related operation for the kinds of respective control operations.

The weight describes the numerical values of the priorities for executing the control operations.

The increments of the weight set the rule for increasing the weighted values. For example, when the control operations has been picked up as an execution candidate of the control operations and when the control operations has been executed, the value of a predetermined increments of the weight is added to the numerical value of the weight.

For example, the value of the increments of the weight is incremented by “1” when the control operations are picked up as the operation candidate, and furthermore, “1” is incremented when the control operations are executed. In case of the operation related to the events, for example, it is set to add “1” to the maximum value in the control operations list.

The premise operation is a different control operation from the control operation which needs to be executed before the execution of the control operation.

The related operation is a different control operation from the control operation which relates to the control operations.

For example, FIG. 2 shows that the weight is “100” for the control operation “server-stop” and the related operation is “DB-stop” and “server-start”. For example, it shows that the premise operation of the control operation “application-deployment” is “memory management-size update”, and the related operation is “application-deployment release”.

Further, according to the necessity, a system manager can appropriately add new items to the control operations, the premise operations and the related operation data and update the value of the increments of the weight.

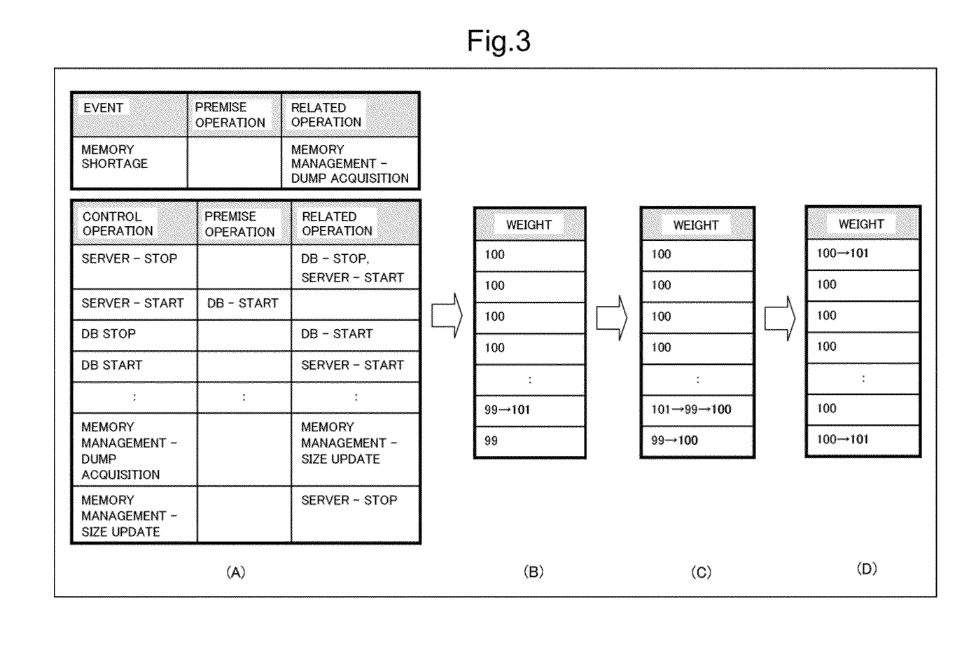

FIG. 3 shows an operation example of the operation management apparatus 10 in the execution prediction management system 30 in the system control operations.

For example, FIG. 3 describes the operation of the operation management apparatus 10 in the case that the event of “memory shortage” occurs during the system operation.

FIG. 3 (a) shows that the related operation of the event “memory shortage” is “memory management-dump acquisition”, the related operation of “memory management-dump acquisition” is “memory management-size update” and the related operation of “memory management-size update” is “server-stop”.

First, as shown in FIG. 3 (b), because the maximum of the weight value to all present control operations is “100”, in the case that “memory management-dump acquisition” has been picked up as a candidate of the related operations, an arithmetic processing unit 12 updates the weighted value for the related actions to “101” by addition of “1” to maximum “100” coming from the present weight “99”.

Next, as shown in FIG. 3 (c), the weight of “memory management-size update” which is the related operation of “memory management-dump acquisition” is added to “100” from “99”, and the operation is executed. Then, because the execution has been completed, “memory management-dump acquisition” updates “100” with adding “1” after subtracting the weighted value “101” and returning it to the original weighted “99” once. Further, this procedure is based on a specified rule because the occurrence of the related operation of an event is a sudden phenomenon.

As shown in FIG. 3 (d), with the execution of “memory management-size update” by a system operator, the weight is updated to “101” by the addition. Concerning to “server-stop” which is the related operation of “memory management-size update”, the weighted is also added, and the arithmetic processing unit 12 updates the value to “101”.

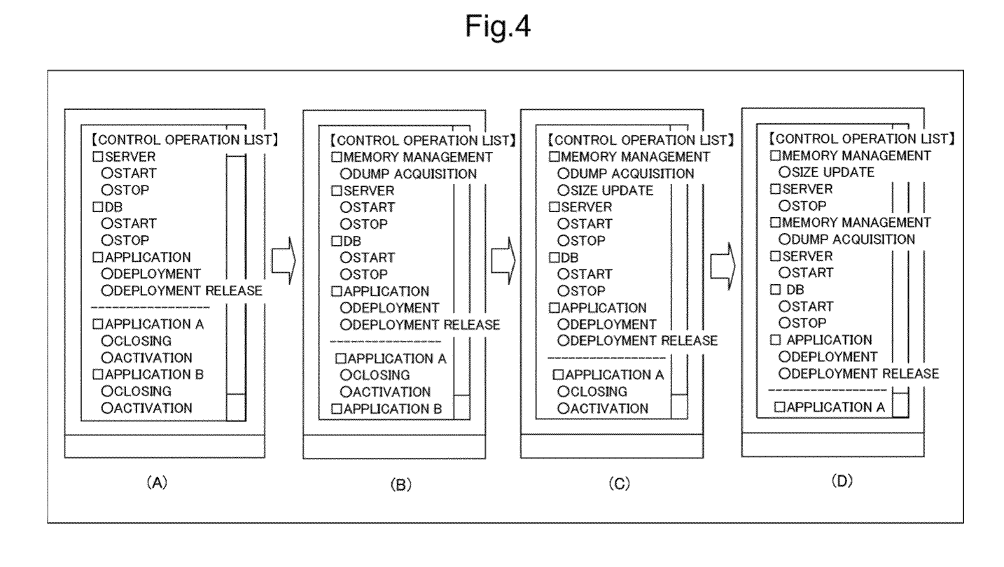

FIG. 4 shows a screen example of the client terminal 20 in the execution prediction management system 30 of the system control operations.

The client terminal 20 reflects the updated result of the weight of each control operation and displays in order of the weight value.

FIG. 4 (a) to (d) corresponds to FIG. 3 (a) to (d), and, for example, “memory management-dump acquisition” whose weight value is the largest, is shown in the top of FIG. 4 (b), and “memory management-size update” is also similarly shown in the top of FIG. 4 (c) and FIG. 4 (d).

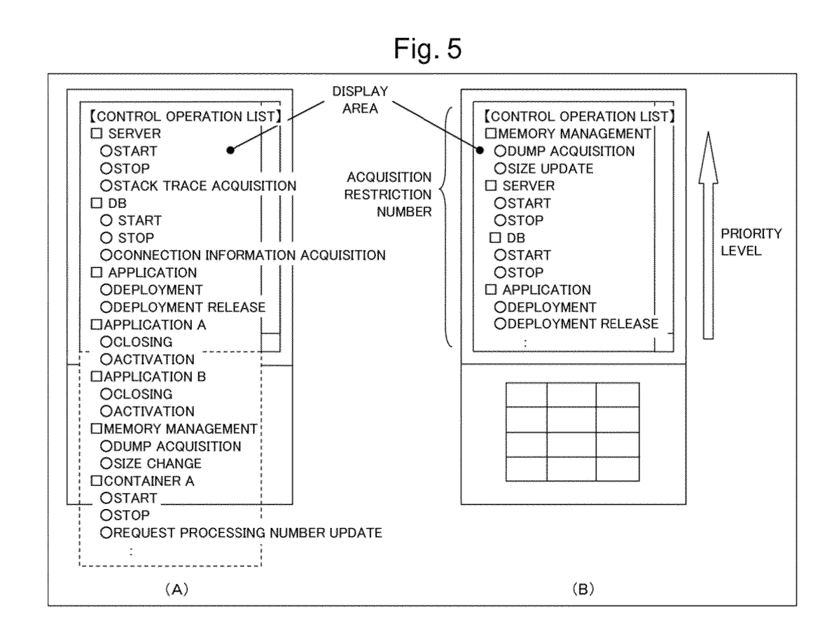

FIG. 5 shows a screen example of control operations in the client terminal 20.

FIG. 5 (a) shows an example of a screen in the case that neither acquisition restriction number of the control operations is implemented nor the priority is considered. In this case, the target operation information is not accommodated in a screen. For this reason, the time is needed for the discovery of the operation information. There is still a problem that the communication traffic increases and the system load also increases.

In contrast, FIG. 5 (b) shows a case that the acquisition number is restricted. In this case, it is possible to display the requested volume of the control operations in order of the control operations with larger execution possibility with the higher priority.

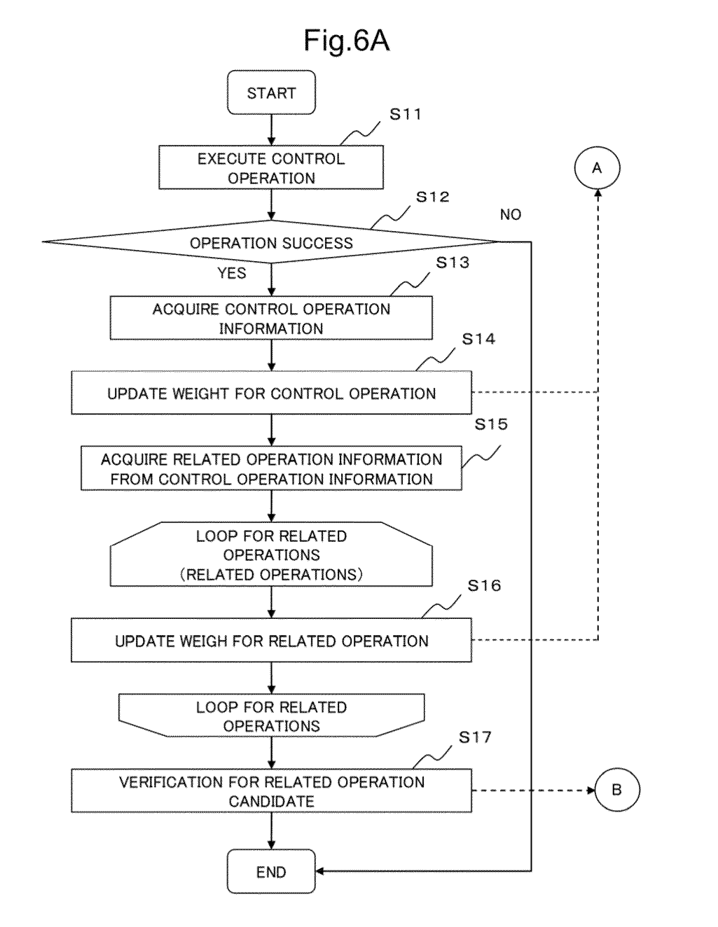

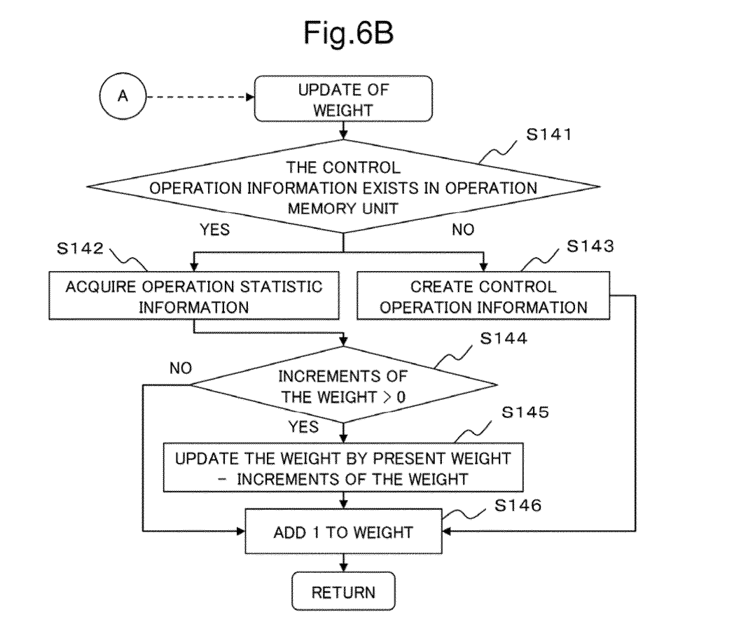

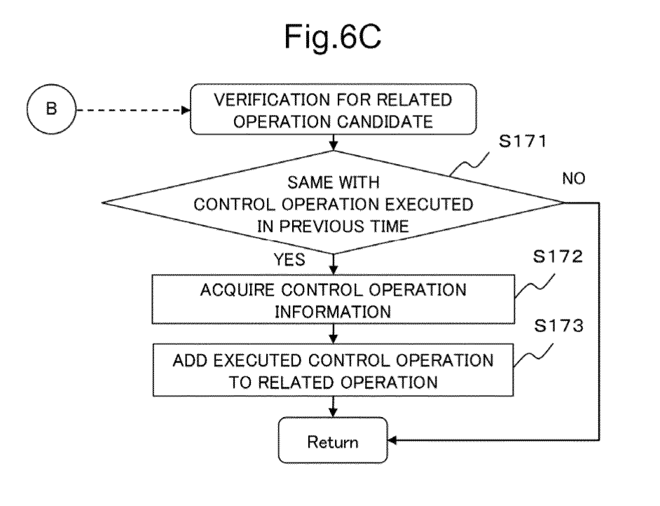

FIG. 6A is a flowchart which shows the operations of the operation management apparatus 10 when carrying out the control operations. Further, a portion (S16, for example) picked up by two trapezoids has looped according to the condition described between the trapezoids.

FIG. 6A describes the operation in the operation management apparatus 10 when carrying out the control operations.

The system operator executes the control operations concerning to the construction and the operation of the system after the operation management apparatus 10 has started (S11).

In that case, the operation management apparatus 10 confirms the success of the control operations (S12).

When the operation has been succeeded in, the arithmetic processing unit 13 acquires the information concerning to the control operations whose execution has completed from the operation memory unit 110 (S13), updates the weighted (S14) and returns it to the operation memory unit 110.

FIG. 6B describes the details of the weight update operation of (S16) in FIG. 6A. The arithmetic processing unit 13 confirms whether the related operation information exists in the operation memory unit 110 (S141), and acquires the information (S142) if existing (YES in S141) while creates the related operation information based on the information acquired from the operation memory unit 110 (S143) if not existing (NO in 141).

Here, the arithmetic processing unit 13 carries out the operation to the weight value of the control operation information based on the information acquired from the operation memory unit 110. This means that the weight value is added by the sudden phenomenon such as the obstruction which has occurred in advance and the weight degree has increased in the case that the increments value of the weight satisfies the condition (S144).

Therefore, the arithmetic processing unit 13 has assumed that the operation has completed for the phenomenon that has occurred by the operation success, and returns this value once to the value before the phenomenon occurrence (S 145).

The calculation formula corresponding to this is described below.

New weight value=Present weight value−Increments of weight value (1)

The arithmetic processing unit 13 adds the weight value by a certain ratio such as “1” to the weight since the related operations has been carried out (S146). Update operation of the weight ends in this.

Next, the arithmetic processing unit 13 also acquires the information on the related operation similar to the steps mentioned above (S15).

At this time, the arithmetic processing unit 13 also performs the arithmetic processing for the weight under the same condition as the mentioned above in each related operation (S16). The details follow the description (S141-146) in FIG. 6B. Further, in this case, the arithmetic processing unit 13 will paraphrase the control operations with the related operations in (S141-146).

After that, in FIG. 6C, when confirming the existence of the control operation that is related to the control operation performed this time and its sameness with the control operation performed last time (YES in S171), the executed control operation is added to the related operation (S172 and S173).

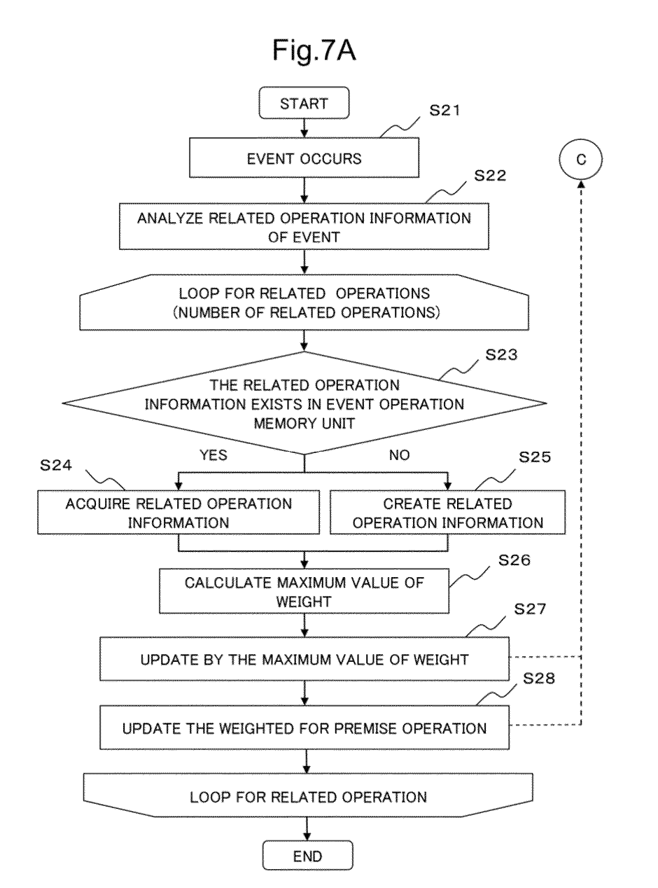

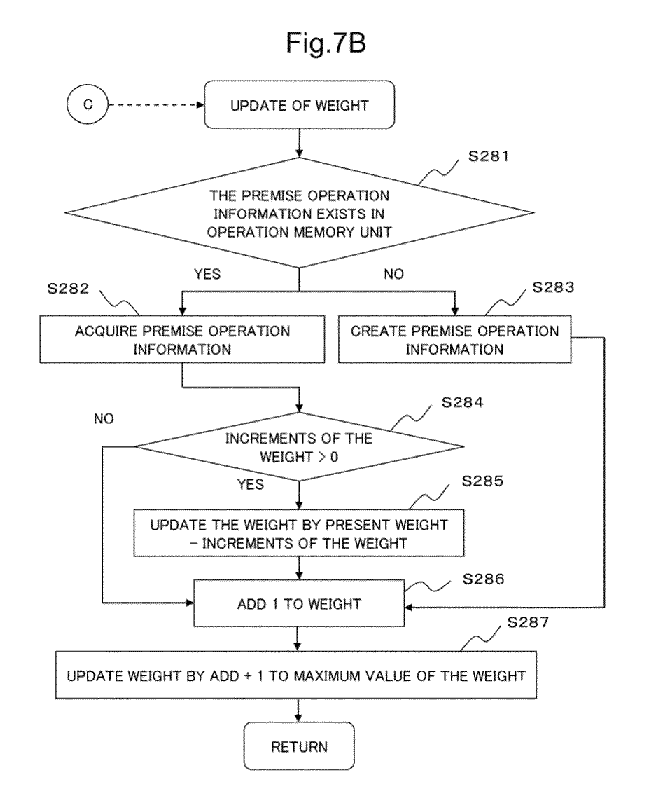

FIG. 7A is a flowchart which shows the operation in the operation management apparatus 10 when an event occurs.

With reference to FIG. 7A, the operation in the operation management apparatus 10 at the event occurrence will be described.

First, when the change and obstruction occur in the state inside the operation management apparatus 10 during the system construction or the system operation, a log processer 18 and a monitoring processer 19 output the events (S21).

When an event detecting unit 17 detects an event, an event analyzing unit 170 analyzes the information on the related operation (S22), and confirms whether the information exists in an event operation memory unit 111 (S23). The information is acquired (S24) when the information exists, while the new control operation data is created based on the information acquired from the operation memory unit 110 (S25) when the information does not exist.

The arithmetic processing unit 13 calculates the value larger than the weight which all control operations held in the operation memory unit based on the information acquired from the event operation memory unit 111 (S26) and updates the weight to the control operations (S27).

This is for a system operator to perform the operation held in the operation memory unit 110 rapidly so that the operation management apparatus 10 may recover the system from a sudden phenomenon such as an obstruction. Concretely, owing to that the arithmetic processing unit 13 makes the weight for the control operations larger than the weight all the candidates of the control operations having at present, the operation will be made recognized preferentially for a system operator.

When an operation processing unit 14 carries out the related operation mentioned above, the arithmetic processing unit 13 updates the weight by adding “1”, for example, to acquire the larger value than the weight with maximum value in the case that the control operation that becomes its premise, that is, the premise action is needed (S28).

FIG. 7B describes the details of the update procedure in (S27/S28) in FIG. 7A. The procedure is similar to the procedure which FIG. 6B has described in (S141-S146). That is, when the related operation indicated above has been carried out, and the operation has succeeded, the possibility that this operation will be carried out preferentially after then is decreased. For this reason, the arithmetic processing unit 13 returns the value of the weight for the related operation to the value of the weight before the event occurrence (S281-286) and updates with adding “1” (S287), following the subtraction of the weight increment mentioned above.

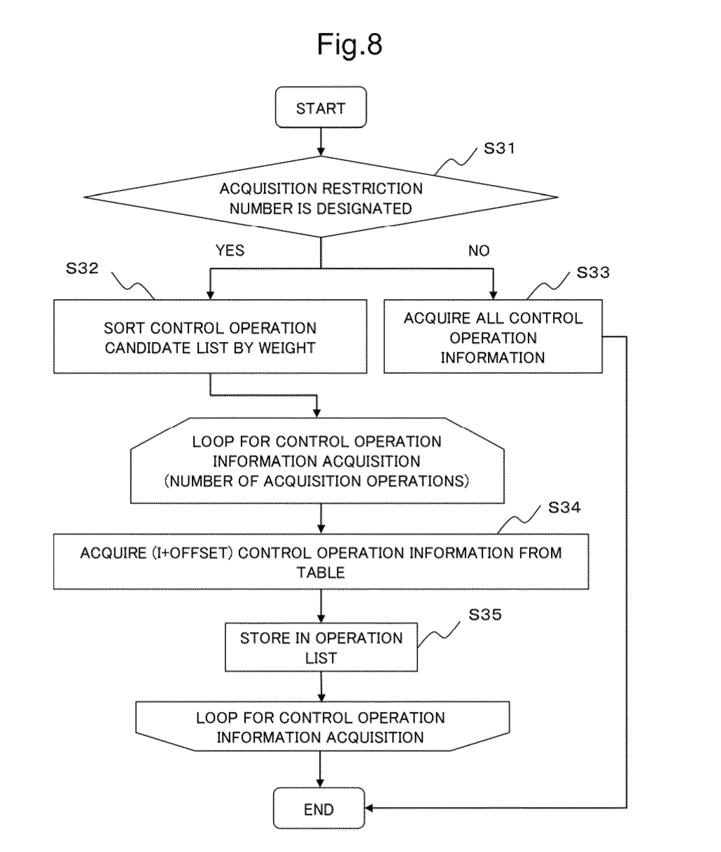

FIG. 8 is a flowchart which shows the operation in the operation management apparatus 10 when corresponding to the request of the restriction number of the acquisition of the control operations.

First, when the system operator requests the control operation information using a client terminal 20, the control operation information acquisition unit 21 requests a list of the control operation information to the operation management apparatus 10 using the acquisition restriction number and the offset value. Further, the acquisition restriction number describes the numerical upper limit value of the control operation information that the client terminal 20 displays. The offset value describes the position of the acquisition when the acquiring control operation information beyond the acquisition restriction number is acquired from an operation management server.

Next, in the operation management apparatus 10, a control operation derivation unit 15 confirms the designation presence of the acquisition restriction number (S31), after the operation request reception unit 16 accepts the request from the client terminal 20. The control operation derivation unit 15 sorts the control operations based on the weight value when the acquisition restriction number is designated (S32), while it acquires all the control operation information when the acquisition restriction number is not designated (S33).

After that, the control operation derivation unit 15 acquires the control operation information with only the volume of required acquisition restriction number in an order of the larger weighted values (S34), stores it in the control operations list (S35) and outputs to the client terminal 20.

The client terminal 20 acquires the control operations list from the operation management apparatus 10, and constructs an operations management screen based on the control operation information by a display control unit 22.

Further, this embodiment may employ the same configuration in which the control operations mentioned above is replaced with the configuration attribute (the setting item) of the web application server. As a result, an execution prediction management system 30 of the system control operations updates the weight to the configuration attribute based on the configuration change by a system operator and an event with log and monitoring processing, derives the configuration attribute which is possible to be updated, and is able to provide a means to show it preferentially in the screen of the client terminal.

This embodiment may be replaced with that the single client terminal 20 connects with a plurality of operation management apparatus 10, that is, a server, and controls using the weight of the control operations acquired from the respective servers. As a result, this embodiment can provide a means which compares not only the control operation information in the single server but also the weight among a plurality of servers and constructs the control operation information, and build a screen in consideration of priority.

The execution prediction management system 30 of the system control operations according to this embodiment provides the effect described on below.

The system operator can predict the control operations to be performed and display them with the proper volume information to the client terminal 20.

The reason is because the target control operations are displayed based on the execution priority.

### Second Exemplary Embodiment

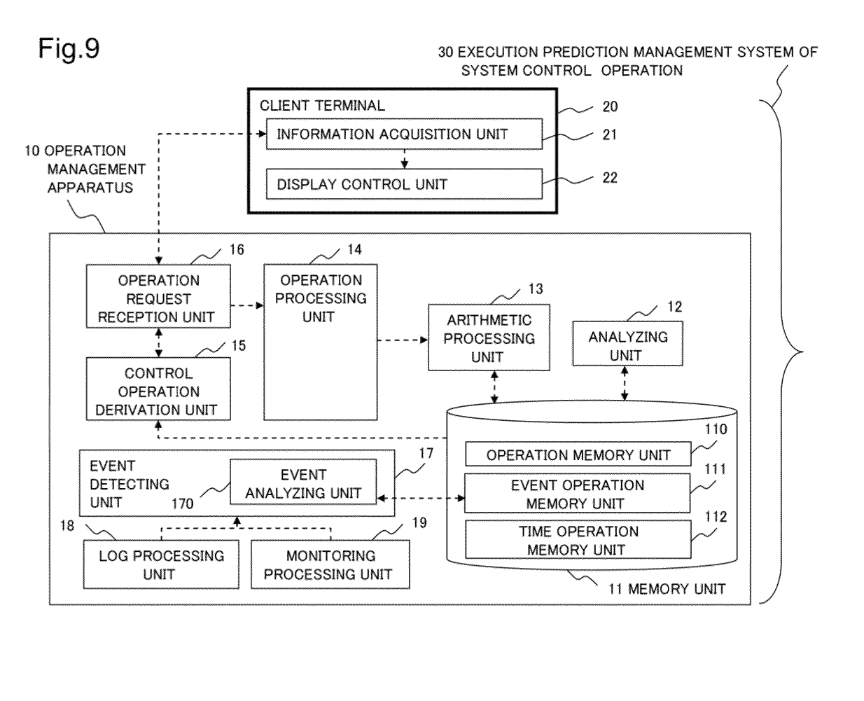

FIG. 9 shows an example of a configuration in an execution prediction management system 30 of system control operations according to the second embodiment.

According to this embodiment, the time operation memory unit 112 is added to the composition of the first embodiment.

Here, the time operation memory unit 112 is a memory storage such as a disk apparatus or a semiconductor memory. The time operation memory unit 112 may be realized by the processor of the operation management apparatus 10, which is a computer, executes a program on the memory which is not illustrated.

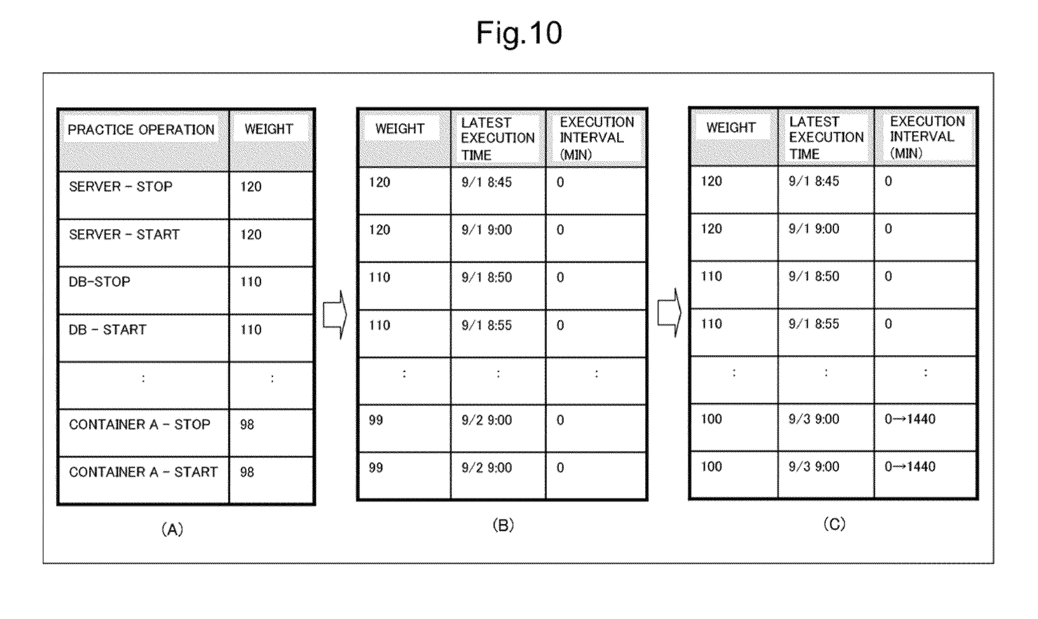

FIG. 10 shows an operation example of an execution prediction management system of the system control operations according to the second embodiment.

FIG. 10 describes the case in which the periodic control operation generates during the system operation. For example, it is supposed that the control operations which restart an operating container A occur at the same time every day. The time when the operation generates is made “9:00” for example, and the kinds of control operations are “container A-stop” and “container A-restart”.

As shown in FIG. 10 (a), the weight values of each operation for the container A are made smaller than the values of other control operations since there have been small utilization frequencies up to now.

FIG. 10 (b) shows the state after carrying out the control operations at “9:00” on the first day (9/2). Here, the last execution time represents the time when the control operations are called finally and have been normally carried out. The execution interval represents the interval of the time when the control operations have been carried out.

As shown in FIG. 10 (c), “Container A-stop” and “container A-restart” are also carried out at “9:00” of the second day (9/3) in the same way as the first day. Here, the execution interval to the first day operation is calculated.

The figure shows the state that the execution interval between “9:00” on the second day and the “9:00” on the first day is calculated to be one day that is, 1440 minutes, and predicts the next execution time of the control operations to be “9:00” on the third day (9/4).

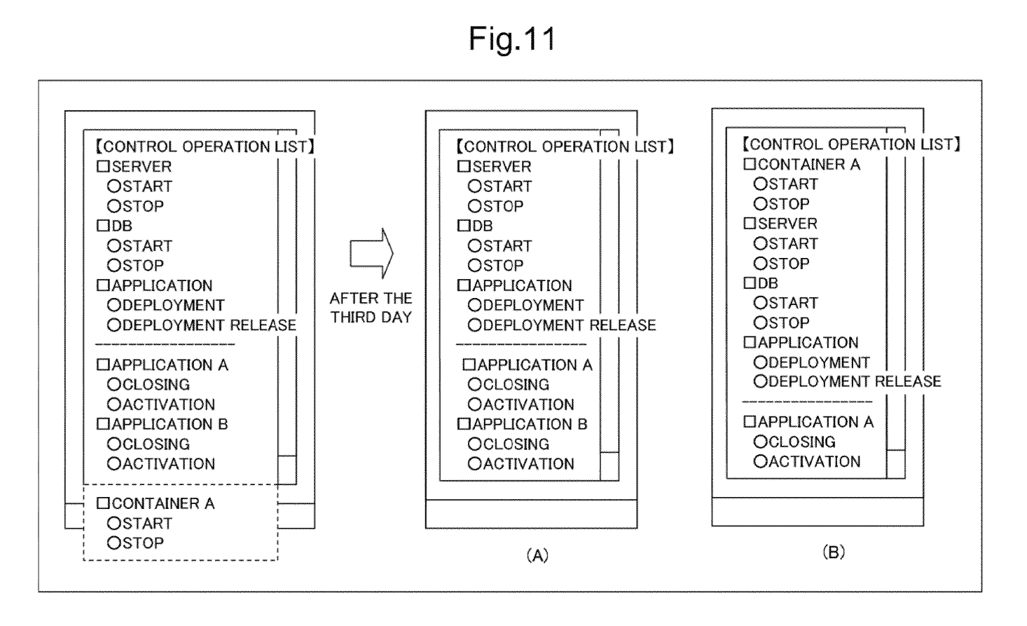

FIG. 11 shows a screen example of the client terminal 20 in the execution prediction management system 30 of system control operations according to the second embodiment.

For example, as shown in FIG. 11 (a), although “container A-stop” and “container A-start” are not displayed in the time other than “8:50-9:10” after the third day from the system operation, at “8:50-9:10”, the client terminal 20 preferentially displays the control operation “container A-stop” and “container A-start” as shown in FIG. 11 (b).

That is, after the third day, when the control operation is requested during the time zone predicted by the operation management apparatus 10 for example at “8:50-9:10” the time when the probability of executing the control operation is high, the operation management apparatus 10 configures the control operation to be preferentially included in the control operations list regardless of the weight.

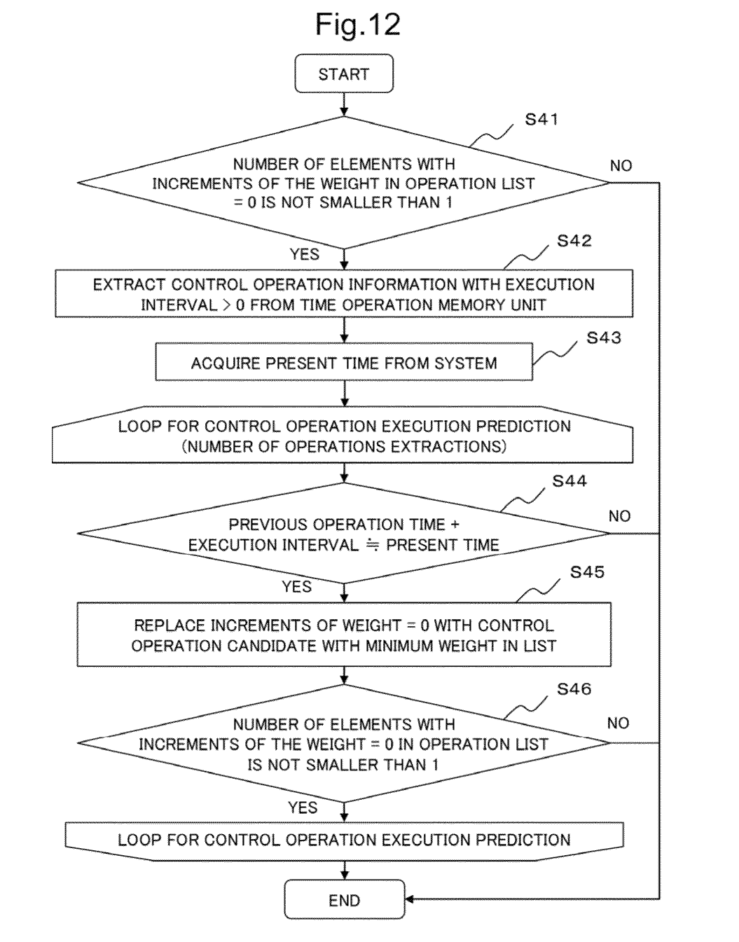

FIG. 12 is a flowchart which shows the operation in the execution prediction management system 30 of system control operations according to the second embodiment.

The control operation derivation unit 15 replaces the control operations in the list so that the control operations may be executed preferentially using the data of the latest execution time and execution interval that each control operation holds when it gets close to the new execution time.

First, the control operation derivation unit 15 extracts the control operation whose execution interval is longer than “0” (S41) from the time operation memory unit 112 (S42) and then acquires the present time (S43). Further, the reason why the control operation whose incremental value of the weighted is “0” in a constant period is the target in the mentioned above is to exclude a sudden phenomenon and target the control operations that periodically occur.

Next, the arithmetic processing unit 13 acquires the previous operation time of the extracted control operation and its operation interval and judges whether the time when it becomes the sum of both is close to the time at present, that is, present time. The reference value which determines whether it is close to the present time or not is set and adjusted properly and the present time is included within 10 minutes of “the latest executing time+the execution interval” for example.

In the case that the control operation information exists which is regarded to be close to the present time as the result of the judgment (S44), the arithmetic processing unit 13 replaces the control operation information whose incremental value of the weighted in the list is “0” to the control operation candidate whose weight is minimum (S45). In addition, the arithmetic processing unit 13 repeats this operation while the control operation candidate exists whose increments of the weight which is the replacement target is “0” (S46).

Further, in case of the operation that predicts the execution of the control operations as shown in this embodiment, it is supposed that only the designated time is shown at the highest rank regardless of the weight as shown in FIG. 11 (b).

The execution prediction management system 30 of system control operations according to this embodiment has the effect described on below.

The required control operations can be predicted at the predetermined time.

The reason is because the time and the control operations are stored after corresponding.

### Third Exemplary Embodiment

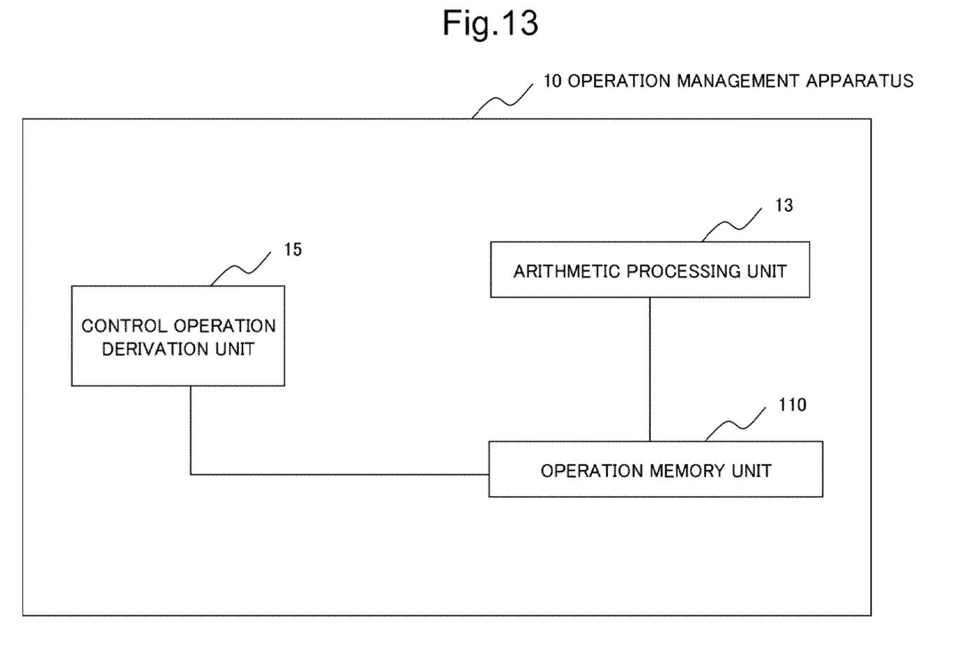

FIG. 13 shows a composition example of the operation management apparatus 10 according to the third embodiment.

The operation management apparatus 10 of this embodiment includes the operation memory unit 110, the arithmetic processing unit 13 and the control operation derivation unit 15.

The operation memory unit 110 corresponds to each of a plurality of control operations and stores the related operation which is the different control operation from the control operation and its priority.

The arithmetic processing unit 13 selects the target operation which is either one of a plurality of control operations from the operation memory unit 110 based on the predetermined condition, increases the priority of the target operation and increases the priority of the related operation corresponding to the target operation.

The control operation derivation unit 15 selects the designated number of the control operations in the priority order from the operation memory unit 110 so as to display them.

The operation management apparatus 10 according to this embodiment provides the effect described on below.

Practical use operation which a system operator carries out is predicted, and it can be displayed by the appropriate amount of information.

The reason is because target control operations are displayed based on the priority of the execution.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. An operation management apparatus comprising:
an operation memory unit that stores a related operation and a priority corresponding to each of a plurality of control operations, the related operation being a different control operation from the corresponding control operations;
an arithmetic processing unit that selects a target operation which is either one of the plurality of said control operations from said operation memory unit based on a predetermined condition, increases said priority of said target operation and increases said priority of said related operation which corresponds to said target operation; and
a control operation derivation unit that selects a designated number of the control operations in the priority order from said operation memory unit and displays the selected control operations.

2. The operation management apparatus according to claim 1 wherein,
said operation memory unit further stores a premise operation corresponding to each of said plurality of the control operations, the premise operation being a different control operation from the corresponding control operation and said corresponding related operation; and
said arithmetic unit increases the priority of said premise operation in addition to said target operation.

3. The operation management apparatus according to claim 1, further comprising:
an event operation memory unit, that memorizes either one of said plurality of the control operations corresponding to each of events that may occur in its own apparatus wherein,
said arithmetic processing unit selects said operation target based on the event that occurs in its own apparatus.

4. The operation management apparatus according to claim 1 further comprising:
a time operation memory unit that memorizes time and either one of said plurality of the control operations wherein,
said arithmetic processing unit selects said operation target based on the time.

5. An operation management method comprising:
storing a related operation and a priority corresponding to each of a plurality of control operations, the related operation being a different control operation from the corresponding control operations;
selecting a target operation which is either one of the plurality of said control operations from said operation memory unit based on a predetermined condition, increases said priority of said target operation and increases said priority of said related operation which corresponds to said target operation; and
selecting a designated number of the control operations in the priority order from said operation memory unit and displays the selected control operations.

6. The operation management method of claim 5, further comprising:
storing a premise operation corresponding to each of said plurality of the control operations, the premise operation being a different control operation from the corresponding control operation and said corresponding related operation; and
increasing the priority of said premise operation in addition to said target operation.

7. The operation management method of claim 5, further comprising:
memorizing either one of said plurality of the control operations corresponding to each of events that may occur in its own apparatus; and
selecting said operation target based on the event that occurs in its own apparatus.

8. A non-transient computer-readable recording medium recording thereon a program which makes a computer function as:
an operation memory unit that stores a related operation and a priority corresponding to each of a plurality of control operations, the related operation being a different control operation from the corresponding control operations,
an arithmetic processing unit that selects a target operation which is either one of the plurality of said control operations from said operation memory unit based on a predetermined condition, increases said priority of said target operation and increases said priority of said related operation which corresponds to said target operation; and
a control operation derivation unit that selects a designated number of the control operations in the priority order from said operation memory unit and displays the selected control operations.

9. The computer-readable recording medium according to claim 8, recording thereon said program which makes said computer function as:
said operation memory unit that further stores a premise operation corresponding to each of said plurality of the control operations, the premise operation being a different control operation from the corresponding control operation and said corresponding related operation; and
said arithmetic unit that increases the priority of said premise operation in addition to said target operation.

10. The computer-readable recording medium according to claim 8, recording thereon said program which makes said computer function as:
an event operation memory unit, that memorizes either one of said plurality of the control operations corresponding to each of events that may occur in its own apparatus; and
said arithmetic processing unit that selects said operation target based on the event that occurs in its own apparatus.

11. An operation management apparatus comprising:
an operation memory means for storing a related operation and a priority corresponding to each of a plurality of control operations, the related operation being a different control operation from the corresponding control operations;
an arithmetic processing means for selecting a target operation which is either one of the plurality of said control operations from said operation memory unit based on a predetermined condition, increasing said priority of said target operation and increasing said priority of said related operation which corresponds to said target operation; and
a control operation derivation means for selecting a designated number of the control operations in the priority order from said operation memory unit and displaying the selected control operations.
